(19) United States
(12) Patent Application Publication
(10) Pub. No.: US 2011/0161199 A1
(43) Pub. Date: Jun. 30, 2011

(54) METHODS AND SYSTEMS FOR PERISHABLE PRODUCT MANAGEMENT

(76) Inventor: Jason Troia, San Mateo, CA (US)

(21) Appl. No.: 12/982,576

(22) Filed: Dec. 30, 2010

Related U.S. Application Data
(60) Provisional application No. 61/291,670, filed on Dec. 31, 2009.

(51) Int. Cl. G06Q 30/00

(52) U.S. Cl. 705/26.81

(57) ABSTRACT

Methods and systems for perishable product management are described. In one embodiment, a produce list of a customer may be accessed. The produce list may be associated with a period of time and including a plurality of produce types. A particular produce type of the plurality of produce types may be identified as not being available as locally grown during the period of time. The plurality of produce types including the particular produce type and at least one remaining produce types. A substitute produce type for the particular produce type may be selected. The substitute produce type is available as being locally grown during the period of time. A local produce percentage may be calculated based on the substitute produce type and the at least one remaining product types. Identification of the local produce percentage and the substitute produce type may be provided. Additional methods and systems are disclosed.

### CROSS-REFERENCE TO RELATED APPLICATIONS

This application claims the benefit of U.S. Provisional Patent Application entitled “METHODS AND SYSTEMS FOR PRODUCE MANAGEMENT”, Ser. No. 61/291,670, filed 31 Dec. 2009 by Jason Troia, the entire contents of which is herein incorporated by reference.

### BRIEF DESCRIPTION OF THE DRAWINGS

FIG. 1 is a block diagram of an example produce system, according to an example embodiment;

FIG. 2 illustrates an example association device that may be deployed in the produce system of FIG. 1, according to an example embodiment;

FIG. 3 illustrates an example management device that may be deployed in the produce system of FIG. 1, according to an example embodiment;

FIG. 4 is a block diagram of an example produce management subsystem that may be deployed within the association device of FIG. 2 and/or the management device of FIG. 3, according to an example embodiment;

FIGS. 5, 6, and 7 are block diagrams of flowcharts illustrating methods for produce management, according to example embodiments;

FIG. 8 is a block diagram of example produce usage data, according to an example embodiment;

FIG. 9 is a block diagram of example produce alternative record, according to an example embodiment; and

FIGS. 10-15 are block diagrams of example displays, according to example embodiments; and

FIG. 16 is a block diagram of a machine in the example form of a computer system within which a set of instructions for causing the machine to perform any one or more of the methodologies discussed herein may be executed.

### DETAILED DESCRIPTION

Example methods and systems for perishable product management are described. In the following description, for purposes of explanation, numerous specific details are set forth in order to provide a thorough understanding of example embodiments. It will be evident, however, to one of ordinary skill in the art that embodiments of the invention may be practiced without these specific details.

While the following example embodiments generally describe perishable products in terms of produce, it should be appreciated that the methods and system described herein may be used with many other types of perishable products and/or grocery products in addition to produce. For example, the methods and systems disclosed herein may be used with any perishable product that can be produced locally with a temporary life span, such as products naturally grown, products produced from an animal, and/or products produced from a product originating from an animal. Specific examples of such products may include: dairy products, meats, cheeses, ocean-based products (e.g., fish, clams, etc.) and the like.

In some embodiments, the methods and systems for produce management enable customers to plan around produce seasonability. In some embodiments, the methods and systems for produce management enable customers to determine what percentage of their produce is locally grown. In some embodiments, the methods and systems for produce management enable customers to adjust their selection of produce to increase their percentage of locally grown produce. In some embodiments, the methods and systems for produce management enable identification of which produce types on a produce list may be substituted to have the greatest increase in a percentage of locally grown produce. In some embodiments, the methods and systems for produce management enable isolation of local farms or growers based on area or zip code.

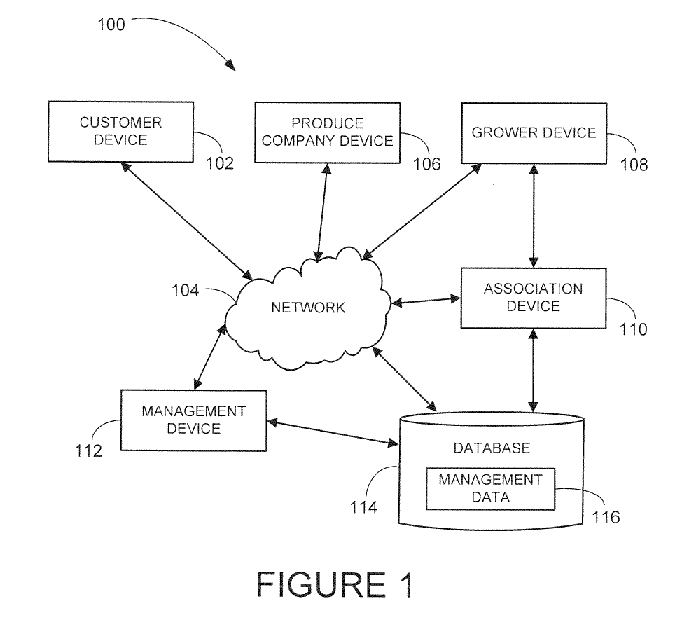

FIG. 1 is a block diagram of an example produce system 100, according to an example embodiment. The produce system 100 includes a customer device 102 by which a customer can communicate over a network 104 with a management device 112 operated by a produce manager to determine produce availability. To determine produce availability, the produce system 100 may further include a produce company device 106, a grower device 108, an association device 110, and/or a database 114.

The customer operates the customer device 102 to assist in its management of produce. The customer may purchase the produce to prepare food items for a menu, groups of individuals, or the like. The customer may manage its produce by planning meals or menu items and selecting corresponding produce as ingredients for these meals or menu items. Examples of customers include stores, restaurants, and institutions. Example institutions include schools, hospitals, and jails.

In some embodiments, the customer provides produce use information and/or purchasing history including produce to the association device 110 or the management device 112. The purchasing history may include specific past purchases or may include generalities and/or approximations with typical produce orders. The use information may include produce purchased and quantity of particular types of produce purchased.

In an example embodiment, the purchasing information may be provided from the customer device 102 to the association device 110 or the management device 112. The server that receives the information may then track the purchasing information of the customer.

In some embodiments, the customer defines a local distance parameter that indicates a number of miles from a farm of a grower that will still be considered local to the customer. The local distance parameter may be stored on the customer device 102, or transmitted to the association device 110 or the management device 112 for storage.

Examples of the network 104 by which the customer device 102 communicates with the association device 110 and/or the management server 112 include Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof Other conventional and/or later developed wired and wireless networks may also be used.

The produce company, through the produce company device 106, may provide a list of growers that it works with to the association device 110, the management device 112, or elsewhere. The produce company device 106 may provide other information to the association device 110, the management device 112.

A grower, through use of the grower device 108, may indicate availability of produce by listing the produce that the grower grows on its farms. The grower may have a single farm or multiple farms. The available produce may be identified by produce type and time available. The indication may be provided to the association device 110, the management device 112, or may be otherwise provided.

In some embodiments, the grower can select the availability of certain produce based on a time selection window. The time selection window may be based of typical growing seasons, historical information, defined by the association associated with the association device 110, or may otherwise be available.

In some embodiments, the grower identifies the produce companies to which it provides produce. In some embodiments, the grower provides usage information and/or purchasing history to the association device 110 and/or the management device 112.

In some embodiments, the grower may also be a produce company. For example, a single farm grower may sell locally grown produce.

The association device 110, when used in the produce system 100, is a server for an association that is associated with a number of different growers. For example, the association may be the Community Alliance with Family Farmers (CAFF) of California. A single association may be associated with the association device 110, or multiple associations with the association device 110.

The association device 110, in some embodiments, maintains a listing of growers in the database 114 that are associated with the association. The listing of growers, in an example embodiment, may be limited to the growers associated with the association. The produce system 100 may then still manage growers that are not associated with the association (e.g., by use of the management device 112).

The association may be in regular contact with growers of its association to provide its growers with services beyond produce management. For example, the association may market the produce that the growers grow. The association may maintain a list of the produce that its growers have made available. The association may directly or indirectly sell product for the growers and/or the produce companies.

The management device 112 enables a customer operating the customer device 102 to manage produce through communication over the network 104 with the produce company device 106 of a produce company, the grower device 108 of a grower, and the association device 110 of an association. For example, a customer may be able to determine, directly through communication with the management device 112 or indirectly through communication through the association device 110, which produce companies the customer can buy produce during a certain period of time to receive locally grown produce.

In some embodiments, the association device 110 and the management device 112 are operated by a single entity. In other embodiments, the association device 110 and the management device 112 are operated by different entities. In some embodiments, the association device 110 and the management device 112 are combined into a single server, while in other embodiments, the association device 110 and the management device 112 are separate servers.

Examples of the devices 102, 106, 108 and the servers 110, 112 include a set-top box, a gaming unit, a receiver card, a set-top box (STB) a mobile phone, a personal digital assistant (PDA), a display device, a generic computing system, or the like. Other devices may also be used. The devices 102, 106, 108 and the servers 110, 112 may each use the same type of device, or may use different types of devices.

The database 114 is shown in FIG. 1 to include management data 116. Management data 116 is data that may be used by the association device 110, the management device 112, or otherwise used. For example, the management data 116 may include a list of growers associated with a particular produce company. Further examples of the management data 116 are described in greater detail below.

The association device 110 and the management device 112 may share the database 114, each have separate databases, only one of the servers 110, 112 may utilize the database 114, or the produce system 100 may be configured otherwise.

While the produce system 100 in FIG. 1 is shown to include single devices 102, 106, 108 and single servers 110, 112, multiple devices and multiple servers may be used. By way of example, the customer may interface with a number of different produce companies, each of which operates a separate produce company device 106. Each of the produce companies may interface with a number of growers, each of which may operate a separate grower device 108. Multiple different associates 110 may be involved with the produce system 100, each of which may have a separate produce association device 110.

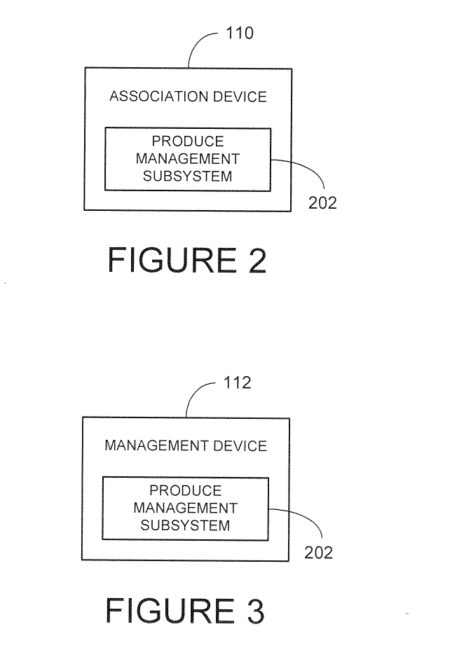

FIG. 2 illustrates the association device 110 (see FIG. 1), according to an example embodiment. The association device 110 includes a produce management subsystem 202. The produce management subsystem 202 identifies types of produce as not being available as locally grown during a period of time and, in some embodiments, suggests alternate types of produce that are available during the period of time. The association device 110 with the produce management subsystem 202 may be deployed in the system 100 (see FIG. 2), or may be deployed in another system.

FIG. 3 illustrates an example management device 112 (see FIG. 1), according to an example embodiment. The management device 112 includes the produce planning subsystem 202 (see FIG. 2). The management device 112 with the produce planning subsystem 202 may be deployed in the produce system 100, or may be deployed in another system.

As shown in FIGS. 2 and 3, the produce management subsystem 202 may be deployed in the association device 110, the management device 112, or in both the association device 110 and the management device 112. The produce management subsystem 202 may also be partially deployed in the association device 110 and partially deployed in the management device 112 so that certain operations are performed by one server and other operations are performed by another server. The produce management subsystem 202 may otherwise be deployed in the produce system 100 or another system.

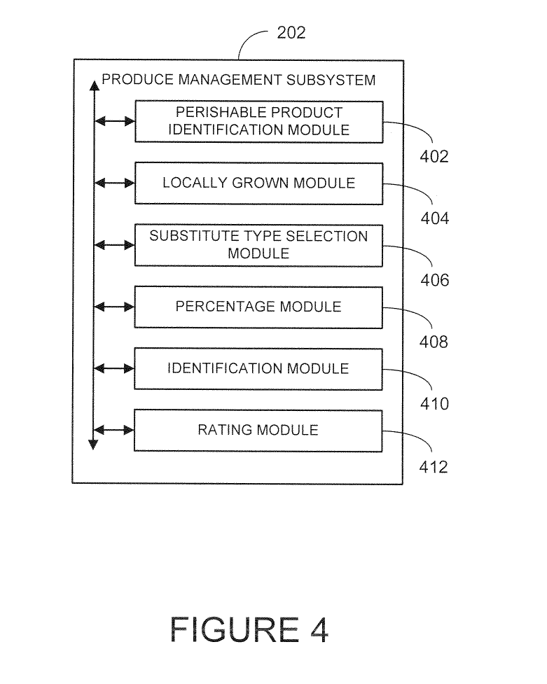

FIG. 4 illustrates an example planning subsystem 400 that may be deployed as the produce planning subsystem 202 in the association device 110 and/or the management device 112, or otherwise deployed in another system (see FIGS. 1 & 2). One or more modules are communicatively coupled and included in the produce planning subsystem 400 to enable identification of types of produce as not being available as locally grown during a period of time and, in some embodiments, suggests alternate types of produce that are available during the period of time. The modules of the produce planning subsystem 400 that may be included are perishable product identification module 402, a locally grown module 404, a substitute produce type selection module 406, a percentage module 408, an identification module 410, and/or a rating module 412. Other modules may also be included. In some embodiments, the modules of the planning subsystem 400 may be distributed so that some of the modules are deployed in the association device 110 and others are deployed in the management device 112.

The perishable product identification module 402 accesses the produce list of the customer. The produce list may be received from the customer through the customer device 102, retrieved from the database 114, or may otherwise be accessed.

In some embodiments, the produce list includes a number of produce types that the customer intends to order during a particular period of time. Thus, the produce list may act as a “wish list”. The produce types that are included on the produce list include fruits, vegetables, or both fruits and vegetables. The period of time may be for a day, a few days, a week, a few weeks, a month, a few months, a year, or the like. The produce list may include quantities of the various produce types on the produce list, or may identify the types of produce without indicating quantities. For example, the produce list may state that a customer intends to order one hundred tomatoes, fifty heads of lettuce, and twenty-five pounds of carrots during a particular week.

In some embodiments, the customer defines the period of time over which the produce on the produce list will be ordered, used, or both ordered and used. In other embodiments, the produce planning subsystem 300 uses a default period of time. The default period of time may be defined for all customers, a subset of customers (e.g., based on customer type), or may be customer specific (e.g., based on past history of the customer). The period of time, whether default or defined, may be received by the produce identification module 402 and stored in the database 114 as part of the management data 116.

The perishable product identification module 402, in some embodiments, may receive a single produce type identified by the customer. The customer may also identify the period of time. The single produce type may then be used for identification purposes by the locally grown module 404 instead of the produce list.

The locally grown module 404 identifies whether produce types are available as being locally grown (as opposed to being not locally grown) during the period of time. For example, one or more produce types listed on the produce list may be identified by the locally grown module 404 as not being locally grown during the period of time. The locally grown module 404 may respond to a query on a specific produce type by identifying whether the specific produce type is available during the period of time.

In some embodiments, the locally grown module 404 determines whether one or more produce types have been identified as being locally grown during the period of time. The determination by the locally grown module 404 may include identifying one or more growers of the produce type and determining whether the produce type has been identified as being available as locally grown by the growers during the period of time. In an example embodiment, one or more growers associated with a particular produce company may be identified and the grower of a particular produce type may be identified from the identified produce company growers.

When the locally grown module 404 identifies a produce type as not available as being locally grown during the period of time, the substitute produce type selection module 406 selects a substitute produce type that is locally grown during the time period for the produce type. The substitute produce type is a type of produce has been identified as being a potential or acceptable substitute for the produce type identified as being not locally grown.

In some embodiments, the locally grown module 404 accesses a list of growers from the management data 116 of the database 114. The identification of whether the produce types are available as being locally grown may then based on the list of growers accessed from the database 114.

In an example embodiment, the locally grown module 404 accesses a local distance parameter. The local distance parameter defines an acceptable distance to the customer (or other entity) that a farm (or grower) may be from the customer while still being considered local. The locally grown module 404 then determines whether the farm of a particular grower (e.g., from the list of growers) or the grower itself is within a certain distance from the customer (e.g., as defined by the local distance parameter). If the farm (or the grower) is within the distance, the produce type associated with the farm of the grower (or the grower) may be considered as being grown locally. If it is not within the distance, the produce type associated with the farm of the grower (or the grower) may not be considered grown locally.

The local distance parameter may be stored in the database 114 as part of the management data. The local distance parameter may be defined for all customers, a subset of customers (e.g., based on customer type), or may be customer specific (e.g., based on past history of the customer or as previously defined by the customer).

In some embodiments, the substitute produce type selection module 406 accesses a produce alternative record from the management data 116 of the database 114 and uses the produce alternative record to identify the substitute produce type for the produce type. In an example embodiment, the substitute produce type may also be identified based on produce alternative record and a price of the substitute produce type. The produce alternative record may be created based on knowledge of available alternatives, alternate produce purchasing history, or the like. The produce alternative record identifies potential substitute produce types for a particular produce type. Personnel associated with the association device 110, the management device 112, or other personnel may create the produce alternative record.

In some embodiments, the percentage module 408 calculates a local produce percentage. The local produce percentage is a percentage of local produce of a number of produce types based on an input received by the percentage module 408. For example, the local produce percentage may be a percentage of local produce on the produce list. The local produce percentage may be based on the number of produce types identified, the number of produce types and the quantity of the produce items identified for possible purchase, or may be calculated otherwise. The percentage module 408 may calculate the local produce percentage based on the original produce types listed on the produce list, based on the substitute produce types and the remaining product types on the produce list, or may otherwise make the local produce percentage calculation.

In some embodiments, the rating module 412 calculates a rating for each produce company based on the amount of locally grown produce purchased by the produce company. For example, the rating may be based on the percentage of the overall purchases made by a produce company that come from local and/or sustainable sources. Additionally, the rating may indicate the sustainability of the produced purchased by a produce company. For example, the rating may be an indication of the sustainability of sea food. The rating allows customers to make informed decisions, based on locality and sustainability, about whether or not to dine at a given establishment.

In some embodiments, the rating module 412 may generate a display at the customer device that includes the rating and/or rating information. For example, a rating associated with a given produce company may appear as a color-coded image of the state in which the produce company is located, with the spending percentage superimposed. The display could be a user interface, a programmable interface, or the like. Alternative methods of display are also contemplated.

In some embodiments, the perishable product identification module 402 accesses a sustainability source list. The identification module 410 may then determine sustainability of a product the produce company and the sustainability list. The ratings module 412 may then make a rating base on the sustainability, the locality, or both.

The identification module 410 provides identification of the local produce percentage based on the original produce list or with one or more substituted produce types, one or more substitute produce types, the produce types being substituted by the substitute produce types, or the like. The identification may be transmitted to the customer device 102 (see FIG. 1), or may be otherwise provided.

In some embodiments, the customer may be a restaurant that stores a menu and/or associated menu items on a local computing device. By use of the planning subsystem 400, the menu may automatically (e.g., without human interaction) or with limited human interaction select dishes for menu inclusion based on local produce available. For example, if pineapples are available as grown locally, a selection of one or more types of desserts are automatically made or made with approval by a user. If pineapples are not available as being grown locally but apples are available, one or more different types of dessert selections are automatically made or made with approval by the user. In an example embodiment, the produce and the associated farm may be identified on the menu.

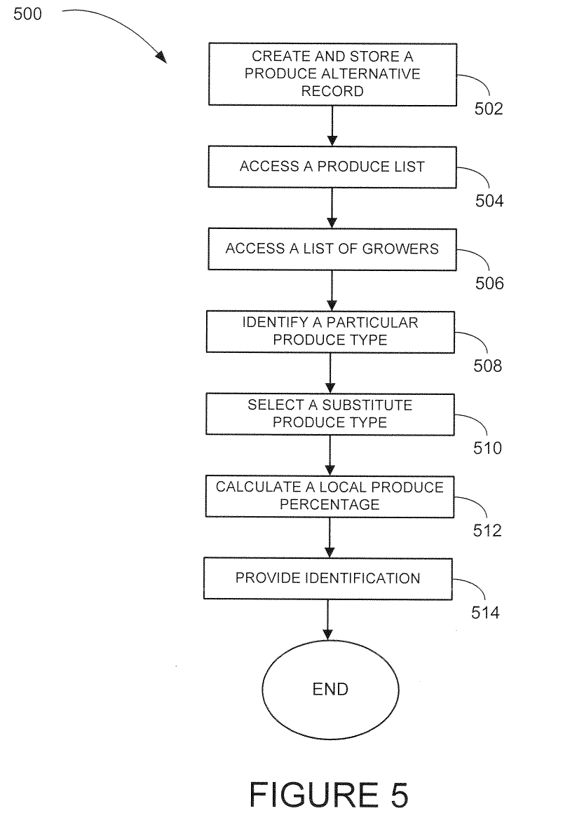

FIG. 5 illustrates a method 500 for produce management according to an example embodiment. The method 500 may be performed by the association device 110, the management device 112, partially by the association device 110 and partially by the management device 112, or may be otherwise performed (see FIG. 1).

In some embodiments, a produce alternative record may be created and stored as a portion of the management data 116 in the database 114 at block 502. In one embodiment, the produce alternative record is created and stored by receiving identification of a produce alternative for the particular produce type, creating the produce alternative record for the particular produce type, and storing the produce alternative record in the database 114. In another embodiment, the produce alternative record is created and stored by accessing alternate produce purchasing history for the particular produce type, creating the produce alternative record for the particular produce type, and storing the produce alternative record in the database 114.

In yet another embodiment, the produce alternative record is created and stored by identifying alternate purchasing history for the particular produce type, creating the produce alternative record for the particular produce type, and storing the produce alternative record in the database 114.

A produce list of a customer is accessed at block 504. The produce list may be associated with a period of time and include a number of produce types. In some embodiments, the produce list includes a quantity for the produce types.

A list of growers may be accessed from the database 114 at block 506.

A particular produce type of the produce types is identified at block 508 as not being available as locally grown during the period of time. The produce types include the particular produce type and at least one remaining produce types. The identification of whether the particular produce is available may be based on the list of the growers. The produce types include fruits, vegetables, or a combination of fruits and vegetables.

In some embodiments, the identification of the particular produce type is based on the accessed list of growers. In some embodiments, a determination of whether the particular produce type has been identified as being available as locally grown during the period of time is made and the identification of the particular produce type is based on the determination that the particular produce type is not locally grown during the period of time is made at block 504.

In an example embodiment, the determination may include identifying a grower of the particular produce type and determining whether the particular produce type has been identified as being available as locally grown by the grower during the period of time. The identification of the grower may include, by way of example, identifying a number of produce company growers associated with a produce company and identifying the grower of the particular produce type from the plurality of produce company growers. The identification of the grower may be otherwise performed.

In an example embodiment, the determination may include identifying a number of growers of the particular produce type and determining whether the particular produce type has been identified as being available as locally grown by at least one grower during the period of time.

A substitute produce type is selected for the particular produce type at block 510. The substitute produce type is determined or otherwise identified as being available as locally grown during the period of time.

In some embodiments, the selection of the substitute produce type is made by accessing the local distance parameter, determining whether the farm of a particular grower from the list of growers is within a permitted distance from the customer based on the local distance parameter, and selecting the substitute produce type for the particular produce type.

In some embodiments, the selection performed at block 510 may include accessing a produce alternative record from the database 114 and identifying the substitute produce type for the particular produce type based on the produce alternative record. In one embodiment, the identification of the substitute produce type includes identifying a number of available substitute produce types for the particular produce type based on the produce alternative record, determining a price for the available substitute produce types, and selecting the substitute produce type for the particular produce type based on a lowest determined price.

A local produce percentage is calculated at block 512 based on the substitute produce type and the remaining product types.

Identification of the local produce percentage, the substitute produce type, and/or the particular produce type are provided at block 514. The identification may be transmitted to the customer device 102, or may be otherwise provided.

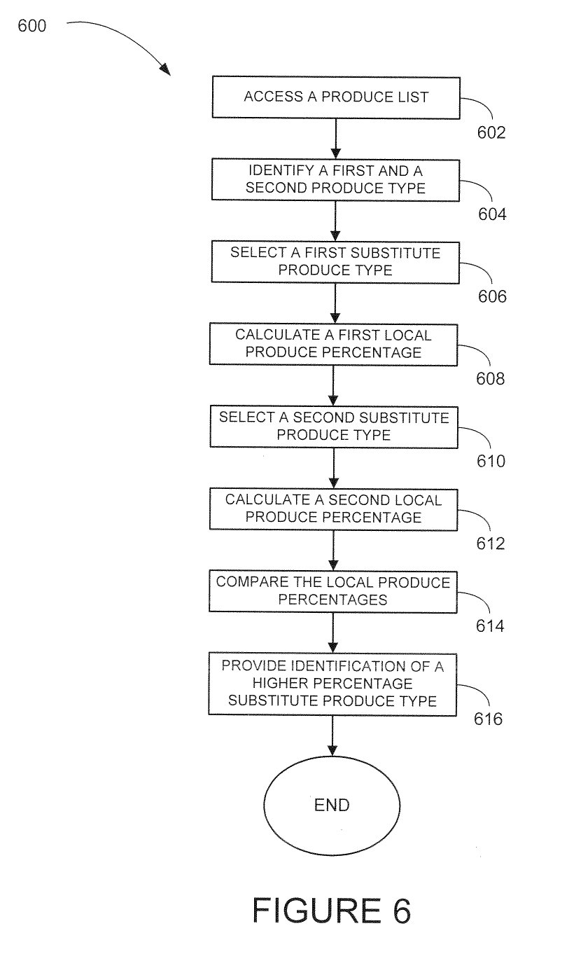

FIG. 6 illustrates a method 600 for produce management according to an example embodiment. The method 600 may be performed by the association device 110, the management device 112, partially by the association device 110 and partially by the management device 112, or may be otherwise performed.

A produce list of a customer is accessed at block 602. The produce list is associated with a period of time and includes a number of produce types.

A first produce type and a second produce type are identified as not being available as locally grown during the period of time at block 604.

A first substitute produce type is selected for the first produce type at block 606.

A first local produce percentage is calculated at block 608 based on the first substitute produce type, the second produce type, and at least one remaining product types.

A second substitute produce is selected type for the second produce type at block 610.

A second local produce percentage is calculated at block 612 based on the first produce type, the second substitute produce type, and at least one remaining product types.

The first local produce percentage and the second local produce percentage are compared at block 614.

Identification of a higher percentage substitute produce type is provided at block 616 based on the comparison.

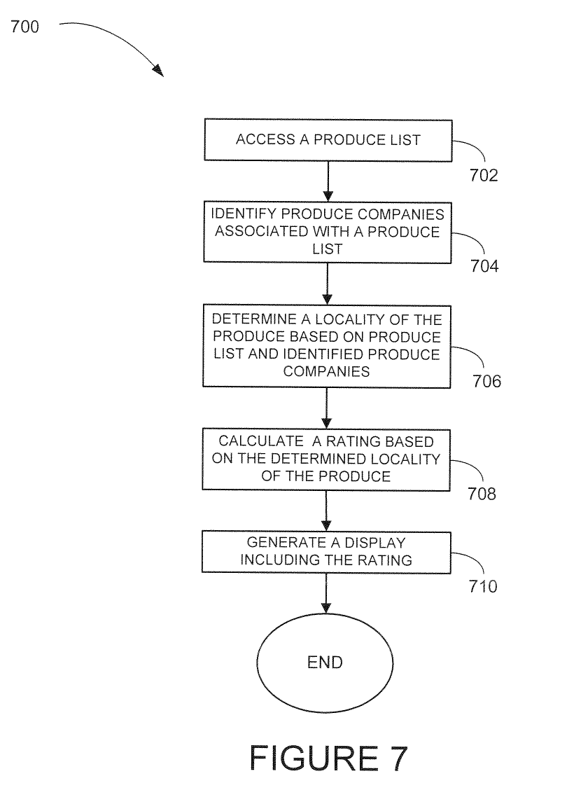

FIG. 7 illustrates a method 700 for produce management according to an example embodiment. The method 700 may be performed by the association device 110, the management device 112, partially by the association device 110 and partially by the management device 112, or may be otherwise performed.

A produce list at of a customer is accessed at block 702. The produce list is associated with a period of time and includes a number of produce types.

At block 704, produce companies associated with the produce list are identified.

The locality of the produce in the produce list is determined based on the produce list and identified produce companies at block 706.

A rating is calculated based on the locality of the produce at block 708.

A display is generated including the rating at block 710.

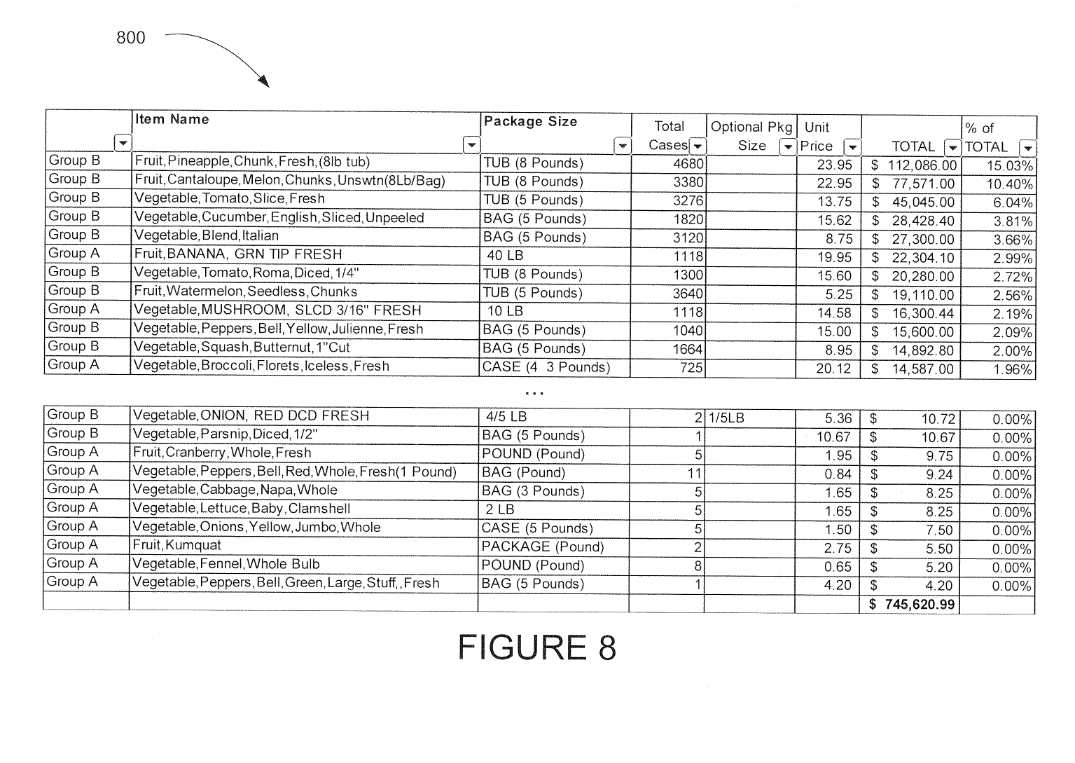

FIG. 8 is a block diagram of example produce usage data 800, according to an example embodiment. The produce usage data 800 is an example list including example items and associated categories. However, different items and categories reflecting different produce may be included in other collections of produce usage data.

The produce usage data 800 shows a partial listing of a number of produce items along with associated information from a variety of categories. The item name of the produce items on the product list may include an item category (e.g., fruit or vegetable), an item name (e.g., pineapple or tomato), a cut of the item (e.g., chuck or slice), and the like.

As shown, the categories associated with the produce item names include package size, total cases, optional package size, unit prize, total, and percentage of total. The package size category identifies the size of the package of the produce items. For example, tub (8 pounds), bag (5 pounds), case (5 pounds), or simply size (10 pounds) may be used for package size. The total cases category identifies the number of cases of the produce item name with the corresponding package size. The optional package size category identifies another possible package size for the produce item name. The unit price category identifies the unit price for the package size of the produce item name. The total category identifies the total price for the produce items of the package size given the total cases and unit price. The percentage of total category identifies the percentage of total spend on the produce item.

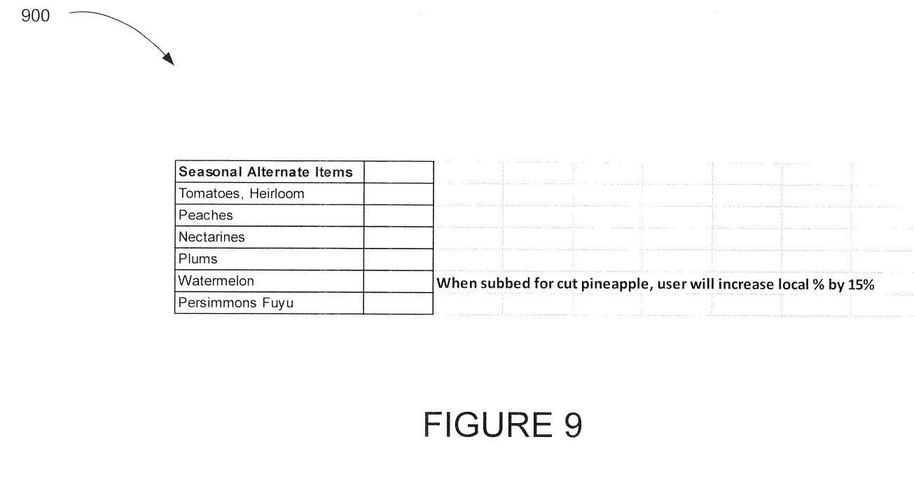

FIG. 9 is a block diagram of example produce alternative record 900, according to an example embodiment. The produce alternative record 900 is an example produce alternative record including example alternate items. However, different alternate be included in other records.

The produce alternative record 900 indicates seasonal alternate items include heirloom tomatoes, peaches, nectarines, plums, watermelons, and fuyu persimmons. As shown, the produce alternative record 900 describes that if cut pineapple were substituted for watermelon, that the local percentage would be increased by fifteen percent.

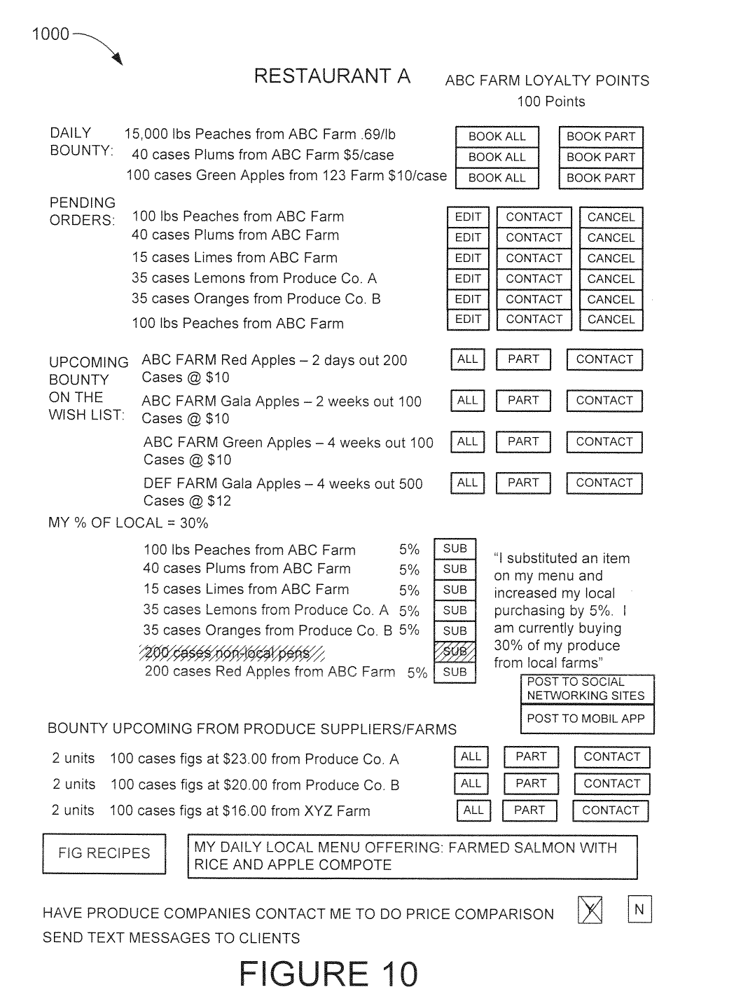

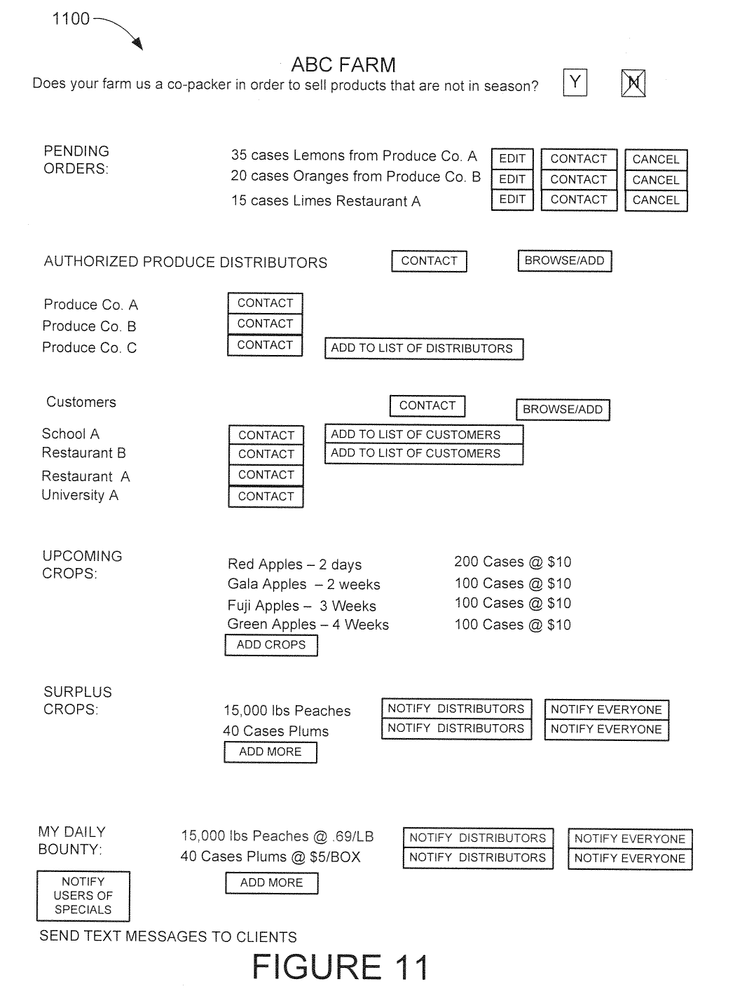

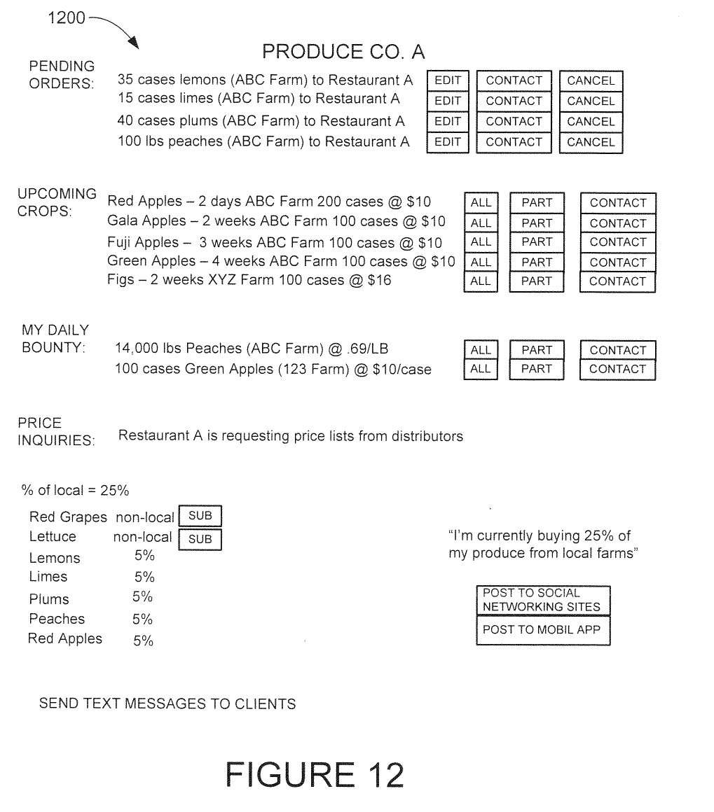

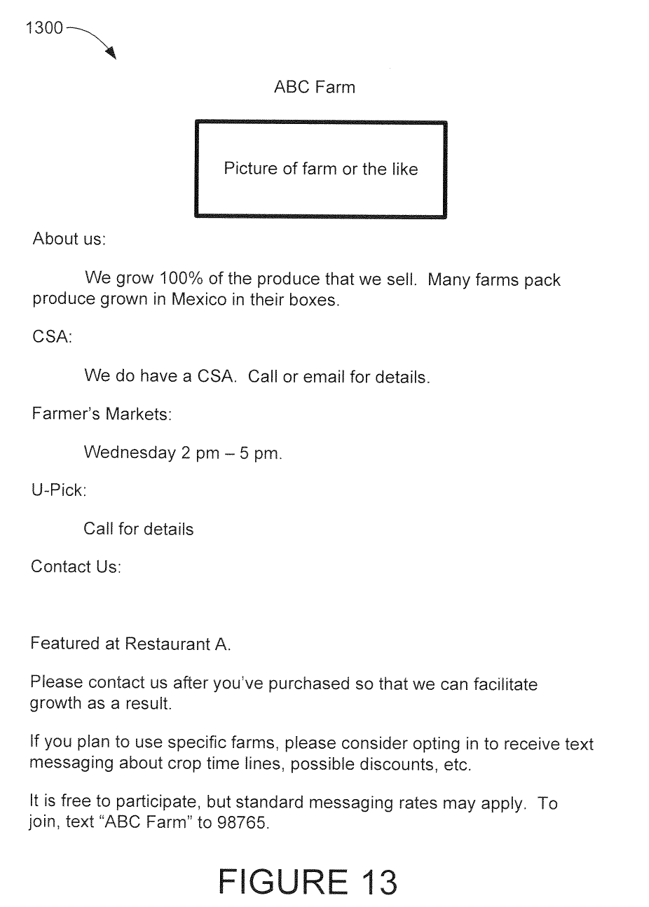

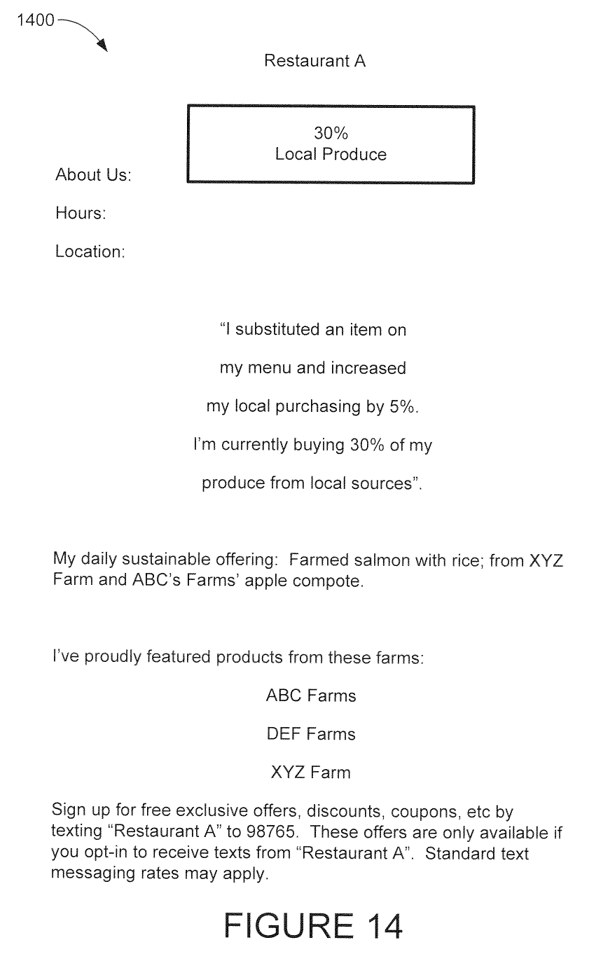

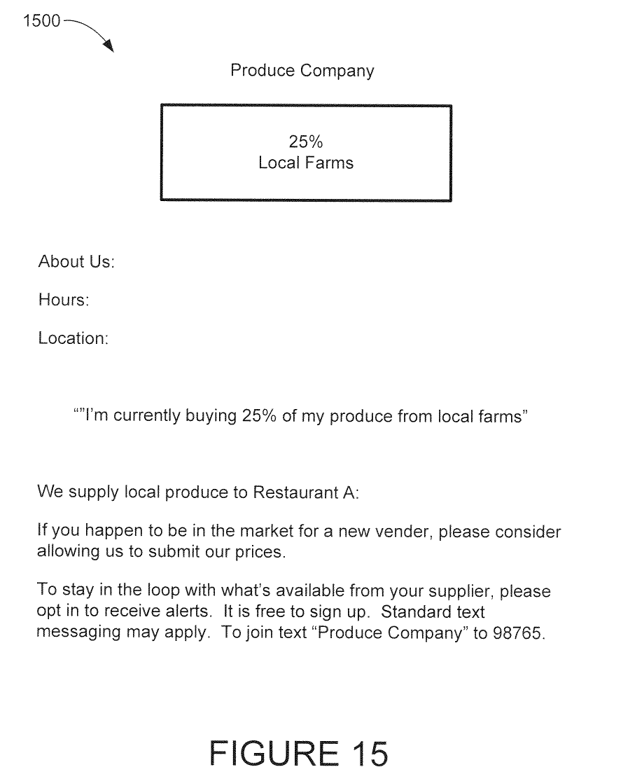

FIGS. 10-15 are block diagrams of example displays, according to example embodiments. The example displays 1000-1500 may be generated and ultimately presented to a variety of the users of the system 100. However, other types of displays and modification to the displays 1000-1500 may also or alternatively be presented.

The display 1000 is an example display that may be displayed to a customer operating the customer device 102. The display 1000 identifies the customer as being Restaurant A.

The display 1000 presents the number of loyalty points earned with ABC farm. In some embodiments, the customer may become associated with and purchase produce from favorite farms. Each time the customer purchases or repurchases from a farm, the customer may be given loyalty points. In some embodiments, loyalty points may be used to determine which customer is awarded a particular type of produce by a farm when stock is in short supply. For example, a customer with the highest number of loyalty points may have an order filled first, a customer with the second highest number of loyalty points may have an order filled second, and so on.

After the initial information described above, the display 1000 includes information sorted by category. These categories include daily bounty, pending orders, upcoming bounty on wish list, my percentage of local, bounty upcoming from product suppliers/farms.

The daily bounty category indicates the produce items that are available for purchase. The customer can elect to purchase some or all of these items through interaction with the display 1000. The pending orders category indicates the produce items that have been ordered on behalf of the customer but have not yet been filled. The customer can elect to edit or cancel the order. The customer can also initiate contact with the produce company (or grower) through interaction with the display 1000.

The upcoming bounty on wish list category indicates the future upcoming bounty that is associated with the wish list of the customer. The customer can book all or part of an order or initiate contact with the produce company or grower through interaction with the display 1000.

The my percentage of local category indicates the total local percentage and breaks down how the total local percentage was derived. As shown, certain produce items contributed five percent each to the total local percentage of thirty percent. Though the display 1000, the customer can elect to substitute one produce item for another. As shown, the display 1000 reflects that two hundred cases of red apples have been from ABC farm have been substituted for two hundred cases of non-local pears. A message may be auto-generated for the display 1000 to reflect the substitution. The message may then be posted to one or more social networking sites, a mobile application associated with the customer, or the like.

The bounty upcoming from product suppliers/farms category indicates the upcoming bounties from produce companies and growers. The customer can book all or part of an order or initiate contact with the produce company or grower through interaction with the display 1000.

The customer can also select to look at recipes associated with the upcoming bounty and/or to look at menu offerings associated with the customer. In addition, the customer can select to have produce companies contact the customer to do a price comparison and/or to send text messages to clients.

The display 1100 is an example display that may be displayed to a grower operating the grower device 108. The display 1100 identifies the grower as being ABC Farm. The grower can indicate in the display 1100 whether the grower uses a co-packer in order to sell products that are not in season.

The display 1100 also indicates the pending orders associated with the grower. The grower can elect to edit or cancel the order. The grower can also initiate contact with the produce company through interaction with the display 1100.

The display 1100 further indicates the authorized produce distributors associated with the grower. The grower can initiate contact with the produce distributors or add a distributor to the list of authorized produce distributors associated with the grower. Finally, the grower can browse the list of produce distributors for potential addition to the list.

The display 1100 also indicates the customers associated with the grower. The grower can initiate contact with the customers or add a customer to the list of customers associated with the grower. Finally, the grower can browse the list of potential customers for potential addition to the list.

The grower can specific the upcoming crops. Previously specified crops may be listed and new crops may be added through interaction with the display 1100. Similarly, surplus crops may be added and viewed. The grower may offer special deals

The daily bounty of the grower may be specified. The grower may notify users of specials and/or send text messages to clients.

The display 1200 is an example display that may be displayed to a product company operating the produce company device 106. The display 1200 identifies the produce company as being Produce Co. A.

The display 1200 also indicates the pending orders associated with the produce company. The produce company can elect to edit or cancel the order. The produce company can also initiate contact with the customer through interaction with the display 1200.

The produce company may view upcoming crops through the display 1200. The produce company may then book all or part of the upcoming crops. Finally, the produce company can also initiate contact with the grower through interaction with the display 1200.

The daily bounty of the produce company may be identified. The produce company may then book all or part of the daily bounty. Finally, the produce company can also initiate contact through interaction with the display 1200.

Price inquiries received from customers may be presented in the display 1200.

The display 1200 may also list the total local percentage and a break down of the local percentage. The produce company can select to substitute produce for non-local produce through interaction with the display 1200.

The produce company can post an auto-generated statement regarding the locality percentage to social networking sites, a mobile application, or the like. Finally, text messages may be sent to clients through interaction with the display 1200.

The displays 1300-1500 reflect example displays that may be presented as part of a mobile application (e.g., an application operating on an iPhone). The display 1300 is a display that may be generated for a grower when the grower device 108 is a mobile device. The display 1400 is a display that may be generated for a customer when the customer device 102 is a mobile device. The display 1500 is a display that may be generated for a produce company when the produce company device 106 is a mobile device.

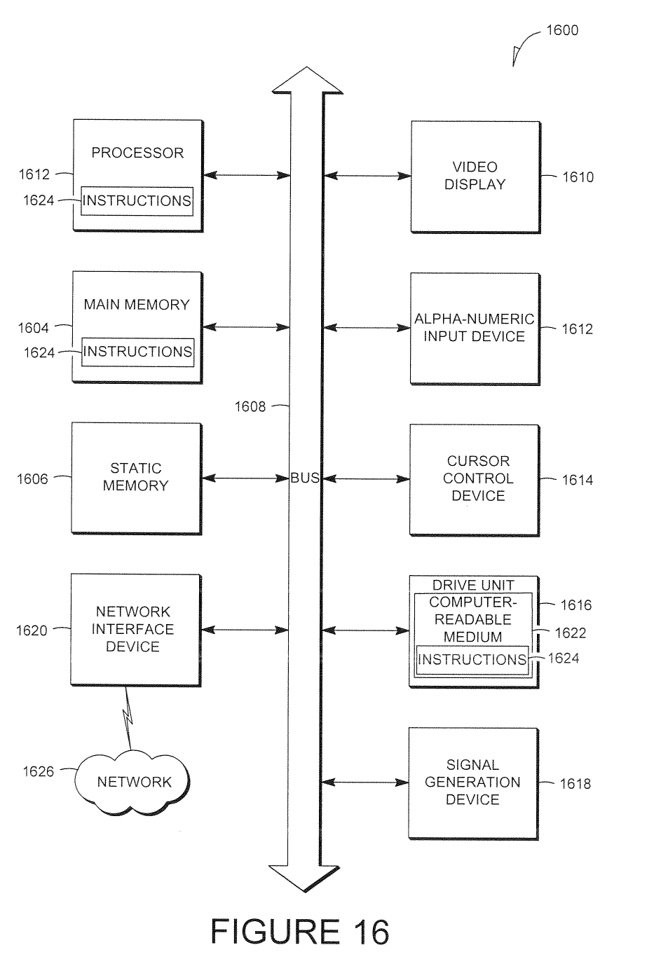

FIG. 16 shows a block diagram of a machine in the example form of a computer system 1600 within which a set of instructions may be executed causing the machine to perform any one or more of the methods, processes, operations, or methodologies discussed herein. The customer device 102, the produce company device 106, the grower device 108, the association device 110, and/or the management device 102 (see FIG. 1) may include the functionality of the one or more computer systems 1600.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1612 (e.g., a central processing unit (CPU) a graphics processing unit (GPU) or both), a main memory 1604 and a static memory 1606, which communicate with each other via a bus 1608. The computer system 1600 may further include a video display unit 1160 (e.g., a liquid crystal display (LCD) or a cathode ray tube (CRT)). The computer system 1600 also includes an alphanumeric input device 1612 (e.g., a keyboard), a cursor control device 1614 (e.g., a mouse), a drive unit 1616, a signal generation device 1618 (e.g., a speaker) and a network interface device 1620.

The drive unit 1616 includes a computer-readable medium 1622 on which is stored one or more sets of instructions (e.g., software 1624) embodying any one or more of the methodologies or functions described herein. The software 1624 may also reside, completely or at least partially, within the main memory 1604 and/or within the processor 1612 during execution thereof by the computer system 1600, the main memory 1604 and the processor 1612 also constituting computer-readable media.

The software 1624 may further be transmitted or received over a network 1626 via the network interface device 1620.

While the computer-readable medium 1622 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present invention. The term “computer-readable medium” shall accordingly be taken to include, but not be limited to, solid-state memories, and optical media, and magnetic media.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled.

The inventive subject matter may be represented in a variety of different embodiments of which there are many possible permutations.

In an example embodiment, a produce list of a customer may be accessed. The produce list may be associated with a period of time and including a plurality of produce types. A particular produce type of the plurality of produce types may be identified as not being available as locally grown during the period of time. The plurality of produce types including the particular produce type and at least one remaining produce types. A substitute produce type for the particular produce type may be selected. The substitute produce type is available as being locally grown during the period of time. A local produce percentage may be calculated based on the substitute produce type and the at least one remaining product types. Identification of the local produce percentage and the substitute produce type may be provided.

In an example embodiment, a produce list of a customer may be accessed. The produce list may be associated with a period of time and including a plurality of produce types. A first produce type and a second produce type of the plurality of produce types may be identified as not being available as locally grown during the period of time. The plurality of produce types may include the first produce type, the second produce type, and at least one remaining produce types. A first substitute produce type may be selected for the first produce type. A first local produce percentage may be calculated based on the first substitute produce type, the second produce type, and the at least one remaining product types. A second substitute produce type may be selected for the second produce type. A second local produce percentage may be calculated based on the first produce type, the second substitute produce type, and the at least one remaining product types. The first local produce percentage and the second local produce percentage may be compared. Identification of a higher percentage substitute produce type may be provided based on the comparing.

Thus, methods and systems for perishable product management have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

The methods described herein do not have to be executed in the order described, or in any particular order. Moreover, various activities described with respect to the methods identified herein can be executed in serial or parallel fashion. Although “End” blocks are shown in the flowcharts, the methods may be performed continuously.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

What is claimed is:

1. A method comprising:
accessing a produce list of a customer, the produce list being associated with a period of time and including a plurality of produce types;
identifying a particular produce type of the plurality of produce types as not being available as locally grown during the period of time, the plurality of produce types including the particular produce type and at least one remaining produce types;
selecting a substitute produce type for the particular produce type, the substitute produce type being available as locally grown during the period of time;
calculating a local produce percentage based on the substitute produce type and the at least one remaining product types; and
providing identification of the local produce percentage and the substitute produce type.

2. The method of claim 1, further comprising:
determining whether the particular produce type has been identified as being available as locally grown during the period of time,
wherein the identifying of the particular produce type is based on a determination that the particular produce type is not locally grown during the period of time.

3. The method of claim 2, wherein the determining comprises:
identifying a grower of the particular produce type, the grower being associated with the customer;
determining whether the particular produce type has been identified as being available as locally grown by the grower during the period of time.

4. The method of claim 3, wherein the identifying of the grower comprises:
identifying a plurality of produce company growers associated with a produce company, the produce company associated with the customer; and
identifying the grower of the particular produce type from the plurality of produce company growers.

5. The method of claim 2, wherein the determining comprises:
identifying a plurality of growers of the particular produce type, the plurality of growers being associated with the customer;
determining whether the particular produce type has been identified as being available as locally grown by at least one grower of the plurality of growers during the period of time.

6. The method of claim 1, wherein the selecting comprises:
accessing a produce alternative record from a database, the produce alternative record being associated with the particular produce type,
identifying the substitute produce type for the particular produce type based on the produce alternative record.

7. The method of claim 6, wherein the identifying of the substitute produce type comprises:
identifying a plurality of available substitute produce types for the particular produce type based on the produce alternative record;
determining a price for each of the plurality of available substitute produce types;
selecting the substitute produce type for the particular produce type based on a lowest determined price.

8. The method of claim 6, further comprising:
receiving identification of a produce alternative for the particular produce type;
creating the produce alternative record for the particular produce type based on the receiving of the identification; and
storing the produce alternative record in the database.

9. The method of claim 6, further comprising:
accessing alternate produce purchasing history for the particular produce type;
creating the produce alternative record for the particular produce type based on the accessing of the alternate purchasing history; and
storing the produce alternative record in the database.

10. The method of claim 6, further comprising:
identifying alternate purchasing history for the particular produce type;
creating the produce alternative record for the particular produce type based on the accessing of the alternate purchasing history; and
storing the produce alternative record in the database.

11. The method of claim 1, further comprising:
providing identification of the particular produce type.

12. The method of claim 1, further comprising:
accessing a list of growers from a database,
wherein the identifying is based on the accessing of the list of growers.

13. The method of claim 12, wherein the selecting of the substitute produce type comprises:
accessing a local distance parameter;
determining whether a farm of a grower from the list of growers is within a permitted distance from the customer based on the local distance parameter,
wherein the selecting is based on a determination that the farm of the grower is within the permitted distance.

14. The method of claim 1, wherein the plurality of produce types include a type of fruit.

15. The method of claim 1, wherein the plurality of produce types include a type of vegetable.

16. The method of claim 1, wherein the produce list further includes a particular quantity for the particular produce type.

17. A method comprising:
accessing a produce list of a customer, the produce list being associated with a period of time and including a plurality of produce types;
identifying a first produce type and a second produce type of the plurality of produce types as not being available as locally grown during the period of time, the plurality of produce types including the first produce type, the second produce type, and at least one remaining produce types;
selecting a first substitute produce type for the first produce type;
calculating a first local produce percentage based on the first substitute produce type, the second produce type, and the at least one remaining product types;
selecting a second substitute produce type for the second produce type;
calculating a second local produce percentage based on the first produce type, the second substitute produce type, and the at least one remaining product types;
comparing the first local produce percentage and the second local produce percentage; and
providing identification of a higher percentage substitute produce type based on the comparing.

18. A method comprising:
accessing a produce list of a customer, the produce list being associated with a period of time and including a plurality of produce types;
identifying at least one produce company associated with the produce list;
determining a locality of a plurality of products, a particular product of the plurality of products being associated with a particular product type of the plurality of produce types, based on the produce list and the at least one produce company; and
determining a rating based on the locality.

19. The method of claim 18, further comprising:
accessing a sustainability source list;
determining sustainability of an additional particular product of the plurality of products based on the at least one produce company and the sustainability list, wherein the rating is based on the locality and the sustainability.

20. The method of claim 18, further comprising:
generating a display based on the rating.
